(19) United States
(12) Patent Application Publication
(10) Pub. No.: US 2002/0178867 A1
(43) Pub. Date: Dec. 5, 2002

(54) Electric corkscrew

(76) Inventor: Man Fai Lun, Hong Kong (HK)

Correspondence Address: JACKSON WALKER L.L.P., Suite 2100, 112 E. Pecan Street, San Antonio, TX, 78205, US

(21) Appl. No.: 10/163,328

(22) Filed: Jun. 5, 2002

(30) Foreign Application Priority Data
Jun. 5, 2001 (GB) 0113643

(51) Int. Cl. B67B 7/00

(52) U.S. Cl. 81/3.2

(57) ABSTRACT

An electric corkscrew has a reversible motor for driving a corkscrew spiral. A non-rotatable sleeve has splines that engage around a bottle cork drawn from a top of a bottle and into the sleeve and holds the cork non-rotatable when the motor is reversed. As a result, the spiral forces the cork out of the sleeve.

### BACKGROUND TO THE INVENTION

1. Field of the Invention

The invention relates to electric corkscrews.

2. Background Information

An electric corkscrew has been disclosed in U.S. Pat. No. 5,095,778. In that Patent, an electric reversible motor is used to drive a corkscrew spiral that rides inside a sleeve that is placed over the top of a bottle. The spiral is driven into a cork in the bottle and draws the cork out of the bottle and into the sleeve. When the motor is reversed various mechanical arrangements, including manually nipping the sleeve in one case, prevent the cork rotating so that the cork is driven off the end of the spiral for disposal.

The proposal in U.S. Pat. No. 5,095,778 are not very efficient, requires extra mechanical parts and may be awkward to use.

### SUMMARY OF THE INVENTION

It is an object of the invention to reduce or overcome these problems.

According to the invention there is provided an electric corkscrew having an elongate main housing containing a reversible motor that is coupled to a corkscrew spiral extending along a longitudinal axis of the housing, and a sleeve mounted to the housing and surrounding the spiral, in which the sleeve is formed with inwardly extending protrusions for engaging sides of a cork pulled into the sleeve along the protrusions by the spiral in use and arranged to prevent the cork rotating when the motor is reversed so that the cork is forced out of the sleeve by the spiral.

The sleeve may be integrally formed with the housing.

The sleeve may be non-rotatably longitudinally slidably mounted inside the housing and biased towards a top of the housing.

The protrusions may comprise integrally formed and pointed splines.

There are preferably three protrusions that extend parallel to and are evenly distributed around the longitudinal axis.

The electric corkscrew may include a re-chargeable battery mounted in the housing.

A stand may be provided for supporting the corkscrew in an upright position with the sleeve uppermost.

The stand may have electrical contacts for connection to a mains supply that mate with electrical contacts connected to supply the battery when the electric corkscrew is placed on the stand.

A bottle top wrap seal cutter may fit over a top of the sleeve when not in use to close off the top of the main housing.

### BRIEF DESCRIPTION OF THE DRAWINGS

A corkscrew according to the invention will now be described by way of example with reference to the accompanying drawings in which:

FIG. 1 is an isometric view of the corkscrew and a stand;

FIG. 2 is a sectional elevation of FIG. 1;

FIG. 3 is a top plan view of the corkscrew; and

FIG. 4 is a sectional view showing a top of the corkscrew and a bottle top wrap cover cutter.

### DESCRIPTION OF THE PREFERRED EMBODIMENT

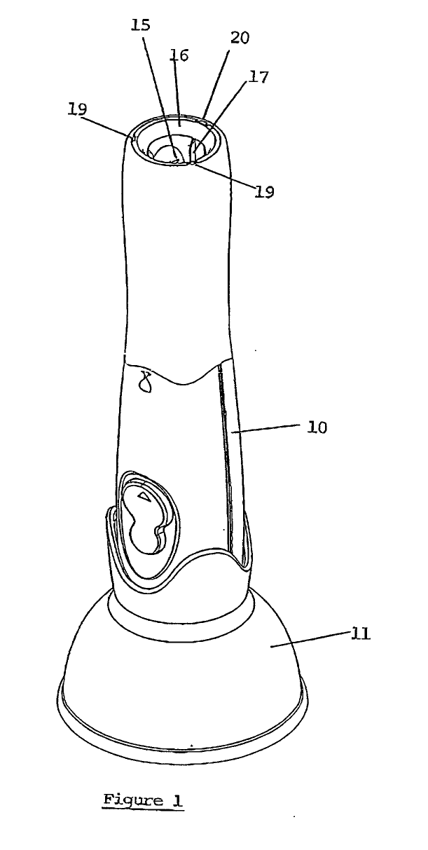

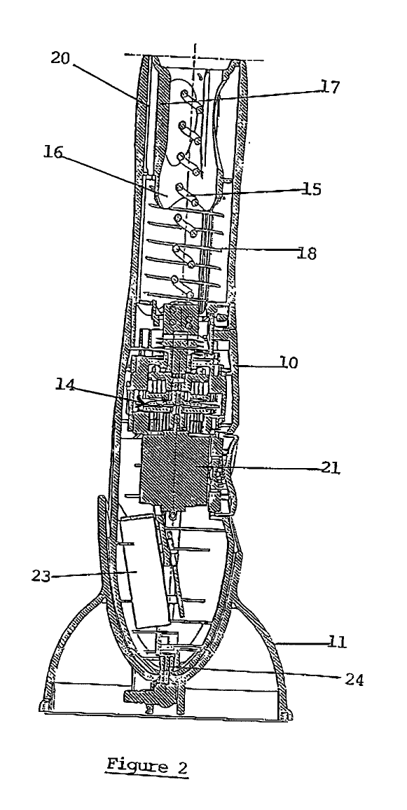

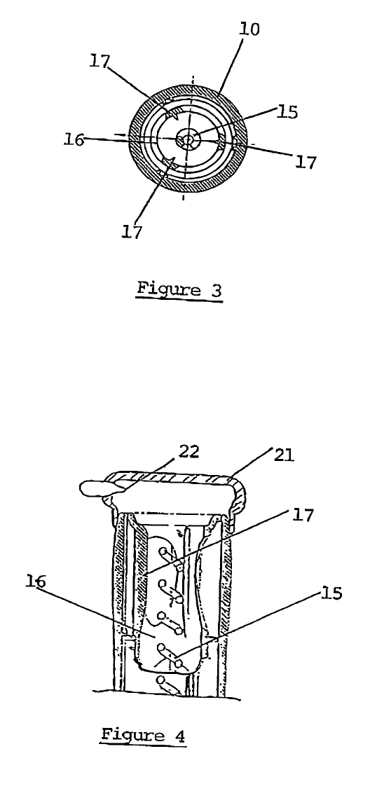

Referring to the drawings, in FIGS. 1 and 2 an elongate corkscrew housing 10 is supported in an upright position in a stand 11. A reversible electric motor 12 is mounted inside the housing and a manually operable switch 13 is provided for controlling the operation and direction of rotation of the motor. The motor 12 is connected via a gearbox 14 to a corkscrew spiral 15 that extends up a central longitudinal axis of the housing 10. A non-rotatable sleeve 16 is held in the housing adjacent a remote (uppermost) end of the housing. The sleeve 16 has three evenly distributed inwardly extending splines 17.

In use, the remote end of the housing is placed over and against a top lip of a corked bottle and the motor 12 is turned ON. The end of the spiral is driven into the cork and pulls the cork into the sleeve 16. As the cork enters the sleeve, the splines 17 cut into the sides of the cork to prevent the cork rotating. At first, the bottle neck will also resist any relative rotation of the cork and so the splines are each normally formed with a lead-in to allow some movement of the cork out of the bottle before the splines bite into the cork. This allows space for the spiral to more easily enter and get hold of the cork, while pressing the housing and the sleeve against the top of the bottle, before the splines offer any resistance to the cork as it first enters inside the sleeve. The motor is operated until the cork is fully removed from the bottle.

In order to allow the cork to be initially removed without being gripped by the sleeve 16, the sleeve may be mounted below the top of the housing 10 by, say, half the length of a normal cork. It will be appreciated that, especially when so mounted below the top of the housing, the sleeve 16, with splines 17, may be integrally formed with and inside the housing 10.

In order to remove the cork from the corkscrew spiral, the motor 12 is reversed to turn the corkscrew spiral in an opposite direction. Because the cork is prevented rotating by the splines of the sleeve the cork is driven by the spiral out of the sleeve 16. No ‘extra’ mechanical parts or arrangement are required for providing this facility and no manual manipulation of the sleeve is necessary.

However, in the preferred embodiment the sleeve 16 is slidably mounted inside the housing and biased by a spring 18. The sleeve 16 has peripheral grooves 19 that slidingly fit over runners 20 integrally formed on an inside surface of the housing 10. Thus, the sleeve can slide into the housing along the runners but is prevented from rotating.

When the sleeve is longitudinally slidable in the housing, during initial withdrawal of a cork the spiral draws the cork into the housing and the cork pushes the sleeve against the bias of the spring into the top of the housing 10. When the sleeve has compressed the spring and is longitudinally arrested by the housing, the spiral begins to draw the cork inside the sleeve. At this time the cork will be substantially withdrawn from the bottle. When the spiral is reversed the cork and the sleeve will be pushed upwards towards the top of the housing 10 until the sleeve reaches and abuts the top of the housing, at which time the cork will continue to be pushed upwards and out of the sleeve.

Advantages of having a biased sliding sleeve are firstly that before use the sleeve surrounds the end of the spiral 15 and makes the corkscrew safer to handle and to use. Secondly, the sleeve moves to a position when the spiral is reversed to adjacent the top of housing where the cork is better exposed to facilitate removal from the housing.

The corkscrew may be provided with an automatic motor STOP. This is conveniently in the form of a proximity switch that is operated by the cork when the cork has fully entered the sleeve, in a manner known per se.

A bottle wrap cover cutter 21, as shown in FIG. 4, fits snugly over, or may be arranged to clip to, the top of the bottle opener. This cutter conveniently and usefully covers the top opening of the housing 10 to prevent debris or small items dropping into the corkscrew through the sleeve 16 when the corkscrew is not in use. The cutter has a resiliently mounted cutting blade 22 that is manually pressed inwards, while the cutter is turned around a top of a bottle to sever around a conventional top bottle seal wrap cover. A severed part of the wrap cover is normally removed before the corkscrew is used to remove the cork.

The corkscrew includes a rechargeable battery 23 and a charging circuit 24. When the corkscrew is on the stand 11, as shown in FIG. 2, electrical contacts 22 automatically mate so that the battery is supplied from a main power supply connected to the stand 11.

The splines 18 may have take other forms, but in all cases consist of protrusions that can be forced into the sides of the cork to prevent rotation of the cork as required. Preferably three splines (or protrusions) are used, which inherently tend to apply even pressure automatically into the side of the cork. However, more splines may be used for some corks, especially plastic corks. For example, a “splined sleeve” may be used, that is a sleeve having a plurality of shallow grooves, say 10 or 12 grooves or splines, because such corks have sides that are more resilient or pliable than the sides of natural cork and better gripped by a splined sleeve.

Where in the foregoing description reference has been made to integers or elements having known equivalents then such are included as if individually set forth herein.

Embodiments of the invention have been described, however it is understood that variations, improvements or modifications can take place without departure from the spirit of the invention or scope of the appended claims.

1. An electric corkscrew having an elongate main housing containing a reversible motor that is coupled to a corkscrew spiral extending along a longitudinal axis of the housing, and a sleeve mounted to the housing and surrounding the spiral, in which the sleeve is formed with inwardly extending protrusions for engaging sides of a cork pulled into the sleeve along the protrusions by the spiral in use and arranged to prevent the cork rotating when the motor is reversed so that the cork is forced out of the sleeve by the spiral.

2. An electric corkscrew according to claim 1, in which the sleeve is integrally formed with the housing.

3. An electric corkscrew according to claim 1, in which the sleeve is non-rotatably longitudinally slidably mounted inside the housing and biased towards a top of the housing.

4. An electric corkscrew according to claim 1, in which the protrusions comprises integrally formed pointed splines.

5. An electric corkscrew according to claim 1, in which there are at least three protrusions that extend parallel to and are evenly distributed around the longitudinal axis.

6. An electric corkscrew according to claim 1, including a re-chargeable battery mounted in the housing.

7. An electric corkscrew according to claim 1, having a stand for supporting the corkscrew in an upright position with the sleeve uppermost.

8. An electric corkscrew according to claim 7, including a re-chargeable battery mounted in the housing and in which the stand has electrical contacts for connection to a mains supply that mate with electrical contacts connected to supply the battery when the electric corkscrew is placed on the stand.

9. An electric corkscrew according to claim 1, having a bottle top wrap seal cutter that fits over a top of the sleeve when not in use to close off the top of the main housing.

10. An electric corkscrew having an elongate main housing containing a reversible motor that is coupled to a corkscrew spiral extending along a longitudinal axis of the housing, and a sleeve integrally formed with the housing and surrounding the spiral, in which the sleeve is formed with inwardly extending protrusions for engaging sides of a cork pulled into the sleeve along the protrusions by the spiral in use and arranged to prevent the cork rotating when the motor is reversed so that the cork is forced out of the sleeve by the spiral, and wherein the inwardly extending protrusions are at least three pointed splines extend parallel to and evenly distributed around the longitudinal axis of the sleeve.
